(19) United States
(12) Patent Application Publication
(10) Pub. No.: US 2020/0125482 A1
(43) Pub. Date: Apr. 23, 2020

(54) CODE EXAMPLES SANDBOX

(71) Applicant: Manhattan Engineering Incorporated, San Francisco, CA (US)

(72) Inventors: Adam Smith, San Francisco, CA (US); Tarak Upadhyaya, San Francisco, CA (US); Juan Lozano, San Francisco, CA (US); Daniel Hung, San Francisco, CA (US)

(21) Appl. No.: 16/657,880

(22) Filed: Oct. 18, 2019

Related U.S. Application Data
(60) Provisional application No. 62/747,143, filed on Oct. 18, 2018.

(51) Int. Cl. G06F 11/36; G06N 3/04; G06F 8/36; G06F 8/33; G06F 8/41

(52) U.S. Cl. CPC G06F 11/3664; G06N 3/04; G06F 8/36; G06F 11/3644; G06F 8/427; G06F 11/3624; G06F 8/33

(57) ABSTRACT

A system and method may provide for identifying and executing code examples in displayed documents. In embodiments disclosed herein, a portion of executable code on a displayed page may be identified, modified, and executed. In one embodiment, a code example may be identified on a web page by a web browser extension, and a code example editing interface displayed to enable editing of the code example in the web browser. An execution environment for the code example may be generated, and the code example executed in a similar context as it was displayed in. For example, a code example may be executed in a web browser. Some embodiments disclosed relate to identifying parameters of a code execution environment, executing code examples remotely, and sharing code examples.

### CROSS-REFERENCE TO RELATED APPLICATIONS

This application claims the benefit of U.S. Provisional Patent Application No. 62/747,143, filed Oct. 18, 2018, which is hereby incorporated by reference in its entirety.

### FIELD OF INVENTION

The present disclosure relates generally to methods and systems for dynamic code example execution during programming and development.

### BACKGROUND

Code examples may be shared on various websites, documentation sources, or code repositories. Examples of code may include small snippets of a larger program that illustrate a concept or feature while omitting other portions of the larger program that do not directly pertain to the illustrated concept or feature. These code examples may be comprised of executable code but are often displayed as plain text for dissemination and distribution. A viewer of a code example such as this may copy and paste the text of the code example into an execution environment and attempt to execute it to evaluate the code more closely or to modify the code to better understand its operation.

### SUMMARY

In some embodiments, a system for interactive display and execution of code examples is provided. In some embodiments, a specification file may be used to specify a computer environment in which the code example is run.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a computer-implemented method including: parsing a displayed page to identify a code example, where the code example is delimited with one or more tags, the page further including text related to the code example; parsing the text to determine one or more attributes of the code example, the attributes including at least a programming language of the code example, a dependency of the code example, and a set of configuration values for a runtime environment for running the code example; creating a containerized image of a server for running the code example, the containerized image including the code example and a server environment configured for running the code example, the server environment configured according to the set of configuration values, and the dependency installed in the server environment; loading the containerized image on a computer system; running the code example on the computer system; capturing the output of the code example and possibly sending it to a remote destination. Other embodiments of this aspect include corresponding computer systems, apparatus, and computer programs recorded on one or more computer storage devices, each configured to perform the actions of the methods.

Implementations may include one or more of the following features. The computer-implemented method where the method is performed in a web browser extension. The computer-implemented method further including providing at least one user input element for customizing the dependency and the set of configuration values. The computer-implemented method where the code example is delimited by a start tag and an end tag. The computer-implemented method where parsing the text to determine one or more attributes of the code example includes using a machine learning model to determine the one or more attributes. The computer-implemented method where the machine learning model is a neural network. Implementations of the described techniques may include hardware, a method or process, or computer software on a computer-accessible medium.

One general aspect includes a computer-implemented method including: parsing a displayed page to identify a code example, where the code example is delimited with one or more tags, the page further including text related to the code example; parsing the text to determine one or more attributes of the code example, the attributes including at least a programming language of the code example, a dependency of the code example, and a set of configuration values for a runtime environment for running the code example; displaying a first interface element for allowing the specification of an identity of an operating system and one or more dependencies for running the code example, the first interface element pre-populated based on the parsed text; displaying a second interface element for allowing the configuration of an operating system environment for running the code example; displaying a third interface element for allowing editing of the code example; displaying a fourth interface element for configuring the output to be displaying based on the running of the code example, the fourth interface element including at least an option for displaying STDOUT and at least an option for displaying STDERR; displaying a fifth interface element for saving code to a community-accessible database; displaying a sixth interface element for initiating running of the code example; running the code example on a server configured according to the contents of the first, second, and fourth interface elements. Other embodiments of this aspect include corresponding computer systems, apparatus, and computer programs recorded on one or more computer storage devices, each configured to perform the actions of the methods.

Implementations may include one or more of the following features. The computer-implemented method where the configuration of the operating system environment includes configuring access to a database. The computer-implemented method where the configuration of the operating system environment includes installing operating system dependencies. The computer-implemented method where the configuration of the operating system environment includes installing and running an additional program to communicate with the code example. The computer-implemented method where the contents of at least one of the first, second, third, and fourth interface element are pre-populated based on a specification file. The computer-implemented method where the contents of at least one of the first, second, third, and fourth interface element are pre-populated based on a template, where the template is configured for use with more than one code example. Implementations of the described techniques may include hardware, a method or process, or computer software on a computer-accessible medium.

One general aspect includes a computer-implemented method including: parsing a displayed page to identify a code example, where the code example is delimited with one or more tags, the page further including text related to the code example; parsing the text to determine one or more attributes of the code example, the attributes including at least a programming language of the code example, a dependency of the code example, and a set of configuration values for a runtime environment for running the code example; loading a specification file, the specification file including one or more attributes including an identity of an operating system and one or more dependencies for running the code example and a set of configuration values of an operating system environment; displaying a first editable interface element; loading from the specification file into the first editable interface element the identity of the operating system and one or more dependencies for running the code example; displaying a second editable interface element; loading from the specification file into the second editable interface element the set of configuration values of the operating system environment; displaying a third editable interface element for allowing editing of the code example; displaying a fourth editable interface element for configuring the output to be displaying based on the running of the code example, the fourth interface element including at least an option for displaying STDOUT and at least an option for displaying STDERR; loading from the specification file into the fourth editable interface element the set of configuration values for displaying output; running the code example on a server configured according to the contents of the first, second, and fourth interface elements. Other embodiments of this aspect include corresponding computer systems, apparatus, and computer programs recorded on one or more computer storage devices, each configured to perform the actions of the methods.

One general aspect includes a computer-readable medium including: a specification file including configuration values for configuring an environment for running a code example; the specification file including an identifier of an operating system, a programming language, and one or more dependencies; the specification file including a plurality of configuration values for the environment. The computer-readable medium also includes the code example; instructions for initializing the environment and running the code example in the environment, where the environment is configured to run the code example with no additional configuration other than the specification file. Other embodiments of this aspect include corresponding computer systems, apparatus, and computer programs recorded on one or more computer storage devices, each configured to perform the actions of the methods.

Implementations may include one or more of the following features. The non-transitory computer-readable medium where the specification file is a template that is configured for use with more than one code example. The non-transitory computer-readable medium where the specification file is in json format. The non-transitory computer-readable medium where the specification file is in YAML format. Implementations of the described techniques may include hardware, a method or process, or computer software on a computer-accessible medium.

One general aspect includes a computer-implemented method including: providing a database of code examples; displaying a first interface element for displaying popular code examples; displaying a second interface element for receiving text entry from the user for searching for code examples; searching for code examples in the database; returning a ranked list of code examples; displaying a third interface element for displaying popular specification files, the specification files for specifying a configuration of a system environment; in response to user input, searching for specification files; receiving an upload of a code example from the user and uploading the code example to the database; receiving an upload of a specification file from the user and uploading the specification file to the database. Other embodiments of this aspect include corresponding computer systems, apparatus, and computer programs recorded on one or more computer storage devices, each configured to perform the actions of the methods.

Implementations may include one or more of the following features. The computer-implemented method where the popular code examples are determined by views. The computer-implemented method where the popular code examples are determined by user ratings. The computer-implemented method where the popular code examples are determined by the frequency with which they have been selected by other users as correct answers to crowd-sourced questions. The computer-implemented method where the ranked list of code examples is ranked by popularity. The computer-implemented method further including: running a code example in response to a request from a user; identifying a similar code example to the running code example, where the similarity is determined based on associated keywords of the similar code example and running code example. Implementations of the described techniques may include hardware, a method or process, or computer software on a computer-accessible medium.

### BRIEF DESCRIPTION OF THE DRAWINGS

The present disclosure will become better understood from the detailed description and the drawings, wherein:

FIG. 1 illustrates an exemplary network environment that may be used in an embodiment;

FIG. 2A illustrates an exemplary machine learning model that may be used in an embodiment;

FIG. 2B illustrates an exemplary machine learning model that may be used in an embodiment;

FIG. 3 illustrates an exemplary system for software development;

FIG. 4 illustrates an example dynamic code example execution system according to an embodiment;

FIG. 5 illustrates the steps of a method of dynamically executing code examples according to an embodiment;

FIG. 6 illustrates an example user interface of an editable dynamic code example execution system according to an embodiment;

FIGS. 7A-B illustrates the steps of a method of editing and dynamically executing code examples according to an embodiment;

FIG. 8 illustrates an example system diagram illustrating a dynamic code example execution system according to an embodiment;

FIGS. 9A-B illustrate the steps of a method of editing and dynamically executing code examples according to an embodiment;

FIG. 10A illustrates a code example execution environment according to an embodiment;

FIGS. 10B-G illustrate exemplary code example features;

FIG. 11 illustrates a code example sharing community according to an embodiment;

FIG. 12A illustrates the steps of a method for sharing code examples according to an embodiment; and

FIG. 12B illustrates an exemplary machine learning network for similarity determination.

FIG. 12C illustrates the steps of a method for training a machine learning network for code example grouping.

FIG. 12D illustrates the steps of a method for searching for code examples by keyword.

FIG. 12E illustrates the steps of a method for searching for code examples based on joint embeddings.

FIG. 12F illustrates the steps of a method for searching for specification files.

FIG. 13 illustrates an example machine of a computer system within which a set of instructions, for causing the machine to perform any one or more of the methodologies discussed herein, may be executed.

### DETAILED DESCRIPTION

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

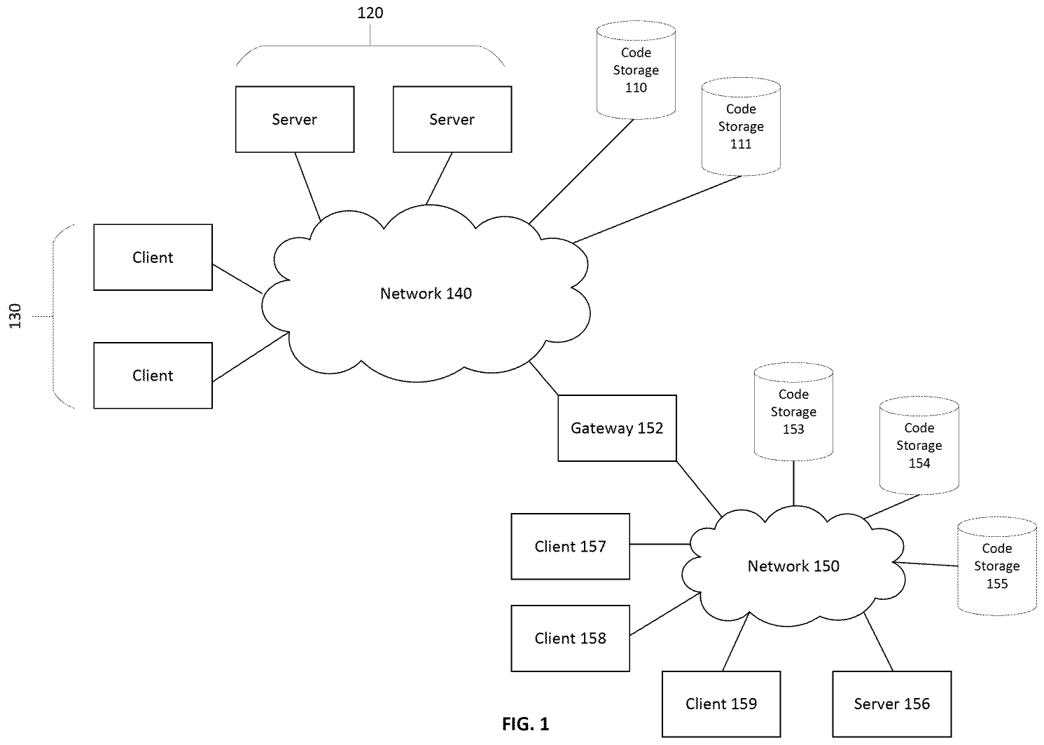

FIG. 1 is a block diagram illustrating an exemplary network environment that may be used in an embodiment. The network environment may include one or more clients and servers connected via a network 140. The network 140 may include a local area network (LAN), a wide area network (WAN), a telephone network, such as the Public Switched Telephone Network (PSTN), an intranet, the Internet, or a combination of networks. The network may include external code storage 110, 111 that store computer code, such as source code. Some external code storage 110, 111 may be globally accessible to any entity on the network 140. Other external code storage 110, 111 may be private and require login-in and authentication to access. The network 140 may include various entities such as servers 120 and clients 130.

Local network 150 may connect to network 140 through gateway 152. In some embodiments, the local network 150 may be private and access controlled so that entities on the network 140 cannot generally access the resources on local network 140. However, entities on the local network 150 may access and share at least some of the resources on the local network 150. Code storage 153 may comprise code stored on the local network 150 after having been web scraped from external code sources 110, 111. Code storage 154 may exist on the local network 150 and may store code from a team of programmers working from clients 157, 158, 159 on the local network 150. In an embodiment, a code storage 156 is an individual code storage that stores code of just one of the programmers on the team. The code storage 156 may be separate from code storage 154 or may be, for example, a subset of code storage 154. In some embodiments, a code storage comprises a codebase, which is a collection of code for building one or a set of software systems, applications, or software components. Code storage may be any kind of storage. In some embodiments, code storage comprises a database. A database is any kind of storage and no particular type of database is required. For example, a database may comprise storage of files in memory or permanent storage.

Additional servers, clients, computer systems, and local networks may be connected to network 140. It should be understood that where the terms server, client, or computer system are used, this includes the use of networked arrangements of multiple devices operating as a server, client, or computer system. For example, distributed or parallel computing may be used.

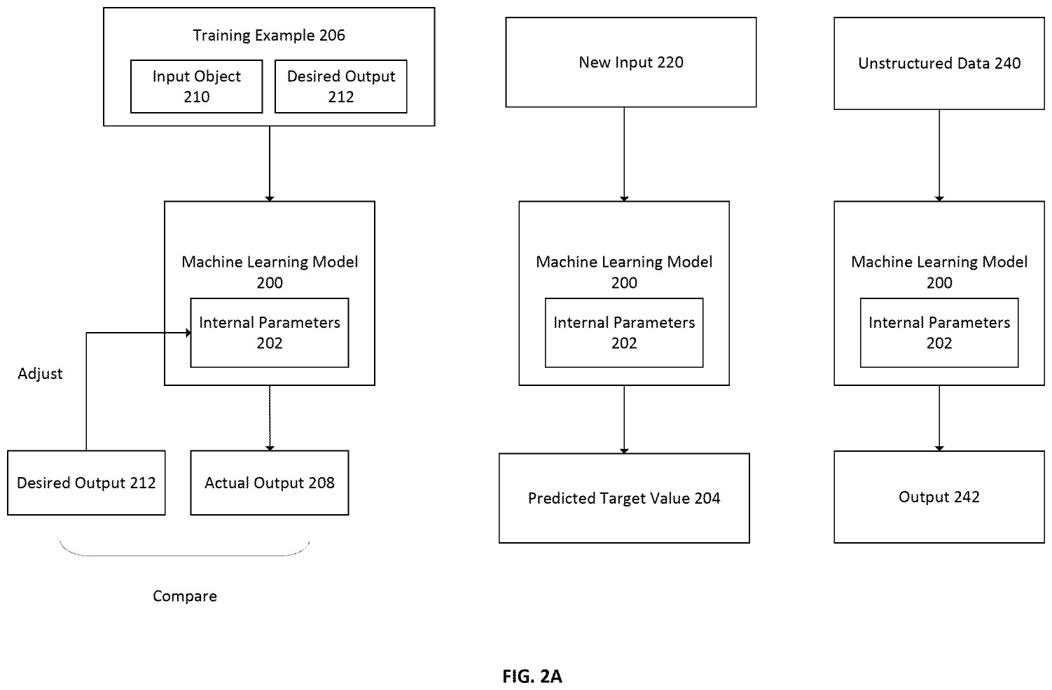

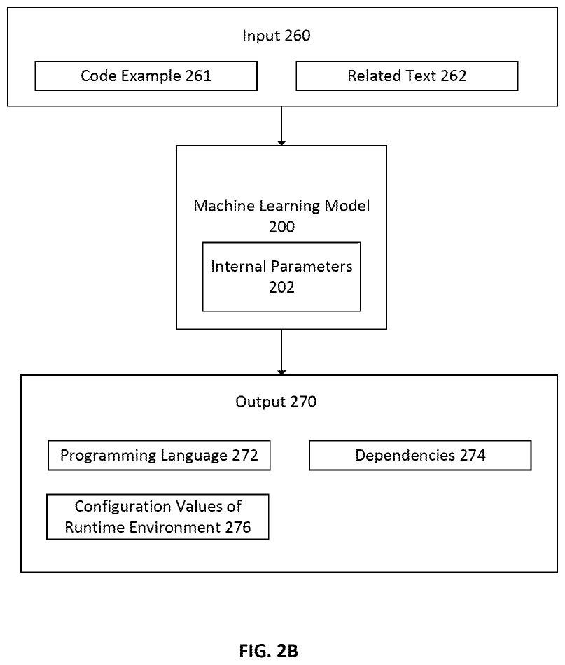

FIG. 2A illustrates an exemplary machine learning model 200. A machine learning model 200 may be a component, module, computer program, system, or algorithm. Some embodiments herein use machine learning for code completion or predictive editing. Machine learning model 200 may be used as the model to power those embodiments described herein. Machine learning model 200 is trained with training examples 206, which may comprise an input object 210 and a desired output value 212. The input object 210 and desired object value 212 may be tensors. A tensor is a matrix of n dimensions where n may be any of 0 (a constant), 1 (an array), 2 (a 2D matrix), 3, 4, or more.

The machine learning model 200 has internal parameters that determine its decision boundary and that determine the output that the machine learning model 200 produces. After each training iteration, comprising inputting the input object 210 of a training example in to the machine learning model 200, the actual output 208 of the machine learning model 200 for the input object 210 is compared to the desired output value 212. One or more internal parameters 202 of the machine learning model 200 may be adjusted such that, upon running the machine learning model 200 with the new parameters, the produced output 208 will be closer to the desired output value 212. If the produced output 208 was already identical to the desired output value 212, then the internal parameters 202 of the machine learning model 200 may be adjusted to reinforce and strengthen those parameters that caused the correct output and reduce and weaken parameters that tended to move away from the correct output.

The machine learning model 200 output may be, for example, a numerical value in the case of regression or an identifier of a category in the case of classifier. A machine learning model trained to perform regression may be referred to as a regression model and a machine learning model trained to perform classification may be referred to as a classifier. The aspects of the input object that may be considered by the machine learning model 200 in making its decision may be referred to as features.

After machine learning model 200 has been trained, a new, unseen input object 220 may be provided as input to the model 200. The machine learning model 200 then produces an output representing a predicted target value 204 for the new input object 220, based on its internal parameters 202 learned from training.

Machine learning model 200 may be, for example, a neural network, support vector machine (SVM), Bayesian network, logistic regression, logistic classification, decision tree, ensemble classifier, or other machine learning model. Machine learning model 200 may be supervised or unsupervised. In the unsupervised case, the machine learning model 200 may identify patterns in unstructured data 240 without training examples 206. Unstructured data 240 is, for example, raw data upon which inference processes are desired to be performed. An unsupervised machine learning model may generate output 242 that comprises data identifying structure or patterns.

A neural network may be comprised of a plurality of neural network nodes, where each node includes input values, a set of weights, and an activation function. The neural network node may calculate the activation function on the input values to produce an output value. The activation function may be a non-linear function computed on the weighted sum of the input values plus an optional constant. In some embodiments, the activation function is logistic, sigmoid, or a hyperbolic tangent function. Neural network nodes may be connected to each other such that the output of one node is the input of another node. Moreover, neural network nodes may be organized into layers, each layer comprising one or more nodes. An input layer may comprise the inputs to the neural network and an output layer may comprise the output of the neural network. A neural network may be trained and update its internal parameters, which comprise the weights of each neural network node, by using backpropagation.

A convolutional neural network (CNN) may be used in some embodiments and is one kind of neural network and machine learning model. A convolutional neural network may include one or more convolutional filters, also known as kernels, that operate on the outputs of the neural network layer that precede it and produce an output to be consumed by the neural network layer subsequent to it. A convolutional filter may have a window in which it operates. The window may be spatially local. A node of the preceding layer may be connected to a node in the current layer if the node of the preceding layer is within the window. If it is not within the window, then it is not connected. A convolutional neural network is one kind of locally connected neural network, which is a neural network where neural network nodes are connected to nodes of a preceding layer that are within a spatially local area. Moreover, a convolutional neural network is one kind of sparsely connected neural network, which is a neural network where most of the nodes of each hidden layer are connected to fewer than half of the nodes in the subsequent layer.

A recurrent neural network (RNN) may be used in some embodiments and is one kind of neural network and machine learning model. A recurrent neural network includes at least one back loop, where the output of at least one neural network node is input into a neural network node of a prior layer. The recurrent neural network maintains state between iterations, such as in the form of a tensor. The state is updated at each iteration, and the state tensor is passed as input to the recurrent neural network at the new iteration.

In some embodiments, the recurrent neural network is a long short-term (LSTM) memory neural network. In some embodiments, the recurrent neural network is a bi-directional LSTM neural network.

A feed forward neural network is another type of a neural network and has no back loops. In some embodiments, a feed forward neural network may be densely connected, meaning that most of the neural network nodes in each layer are connected to most of the neural network nodes in the subsequent layer. In some embodiments, the feed forward neural network is a fully-connected neural network, where each of the neural network nodes is connected to each neural network node in the subsequent layer.

A gated graph sequence neural network (GGSNN) is a type of neural network that may be used in some embodiments. In a GGSNN, the input data is a graph, comprising nodes and edges between the nodes, and the neural network outputs a graph. The graph may be directed or undirected. A propagation step is performed to compute node representations for each node, where node representations may be based on features of the node. An output model maps from node representations and corresponding labels to an output for each node. The output model is defined per node and is a differentiable function that maps to an output.

Neural networks of different types or the same type may be linked together into a sequential or parallel series of neural networks, where subsequent neural networks accept as input the output of one or more preceding neural networks. The combination of multiple neural networks may comprise a single neural network and may be trained from end-to-end using backpropagation from the last neural network through the first neural network.

FIG. 2B illustrates use of the machine learning model 200 to perform inference on input 260 comprising data relevant to dynamic execution code examples. Input 260 may comprise any of code example 261, text 262 that relates to code example 261, or other data. The machine learning model 200 performs inference on the data based on its internal parameters 202 that are learned through training. The machine learning model 200 generates an output 270 comprising information or data relevant to helping determine and configure an execution environment for code example 261, such as a programming language 272 of the code example 261, dependencies 274 of the code example 261, configuration values of a runtime environment 276 for running the code example 261, or other data.

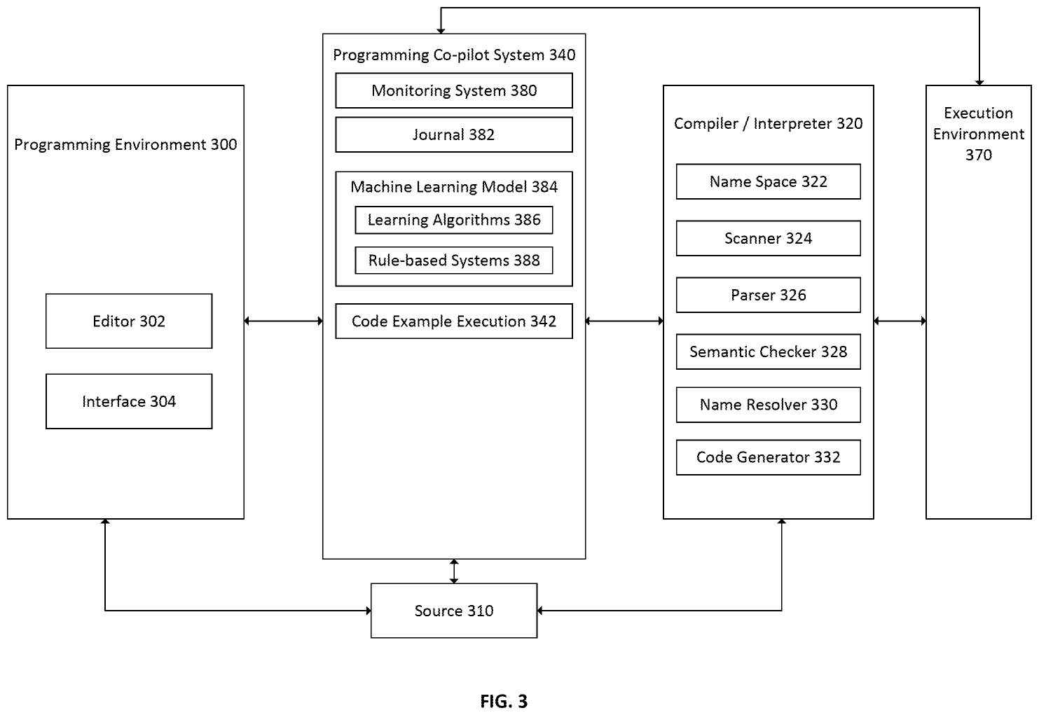

FIG. 3 illustrates an exemplary system for software development. Source code 310 may be provided and edited in a programming environment 300. The programming environment may allow interactive editing of the source code 310 by a user, such as a programmer. A programming environment may include an editor 302 and an interface 304. The editor 302 may provide for the developing, such as writing and editing, of source code 310. The interface 304 may present a human viewable or usable interface for using the editor 302. For example, the interface 304 may comprise a graphical user interface. Many different kinds of editor 302 may be used such as an integrated development environment (IDE), text editor, or command line. In some embodiments, an IDE such as Eclipse, Sublime, Atom, or Visual Studio may be used. In other embodiments, a shell or operating command line such as the Bash command line is used as a programming environment and may comprise an editor 302. In still other embodiments, single input interactive environments, such as Read-Eval-Print Loop (REPL), may be used as the editor 302.

A compiler or interpreter 320 may compile the code 310 into executable instructions or an intermediate representation or interpret the source code 310 for execution. The compiler/interpreter 320 may comprise a namespace 322 that can be used to store symbols, such as identifiers and types, and to allow for name resolution 330. In some embodiments, the compiler/interpreter 320 may comprise a scanner 324, parser 326, semantic checker 328, name resolver 330, and code generator 332. Scanner 324 may accept as input the source code 310 and split expressions and language statements into tokens that can be processed by the parser 326 to determine the grammatical structure of a program. A token may be a single element of a programming language such as a constant, identifier, operator, separator, reserved word, or other element. In some embodiments, a token is atomic and is the smallest semantic unit of a programming language, such that the token cannot be broken down further into units with semantic meaning in the language. The parser 326 may parse the tokens and organize them according to a grammar of a programming language. In some embodiments, parser 326 builds a parse tree. Semantic checker 328 may perform semantic checking of a computer program and may identify and throw errors that are semantic in nature. The name resolver 330 may resolve names in the parse tree to elements of the namespace 322. Code generator 332 may translate the parse tree, or other intermediate representation of the source code, into a target language. The target language may be executable instructions, such as a binary executable, or an intermediate language that may be interpreted for execution.

Programming co-pilot system 340 may interact with the programming environment 300, source code 310, compiler/interpreter 320, and execution environment 370 to provide programming assistance to the programmer. Programming co-pilot 340 may include a monitoring system 380 to monitor user actions in an editor 302 and system events such as inputs, outputs, and errors. Programming co-pilot 340 may also include a journal 382, which may comprise a digital record of the history of data, such as sequential changes to and versions of source code, user interactions in the editor 302, user interactions in other parts of a system such as a terminal or web browser, system events, and other data. The journal 382 may record data sequentially so that a sequence of events may be exactly reconstructed. Programming co-pilot 340 may include functionalities such as code example execution system 342 and other features. Programming co-pilot 340 may include machine learning model 384 to power its functionality, including learning algorithms 386 that learn from data or rule-based systems 388 that use hard-coded rules or heuristics. Although illustrated as one unit, multiple machine learning models 384 may be used in practice to perform or implement different functionality. For example, each function may have a separate machine learning model. Programming co-pilot system 340 may interface with the programming environment 300 through API calls, data streams, inter-process messages, shared data structures, or other methods. In some embodiments, the programming co-pilot 340 is a separate program from the programming environment 300. In other embodiments, the programming co-pilot is a sub-program or component of the programming environment 300.

An embodiment of a programming co-pilot system 340 and its various functionality will be described herein. The programming co-pilot system 340 may include various combinations of the features described herein. In some embodiments, it includes all the functionalities described herein, and, in other embodiments, it includes only a subset of the functionalities described.

Embodiments may operate on any kind of source code including imperative programming languages, declarative code, markup languages, scripting languages, and other code. For example, source code may be Python, Perl, PHP, Javascript, Java, C, C++, HTML, reStructuredText, Markdown, CSS, shell scripts (such as bash, zsh, etc.), and so on.

The programming co-pilot 340 may allow the user to create code examples from his own codebase. For example, co-pilot 340 may include graphical user interfaces, such as those disclosed herein, for creating code examples. These user interfaces may be used to allow a user to create code examples from the user's own codebase or other repositories that the user has access to. Moreover, the programming co-pilot 340 may display code examples uploaded to a community, as disclosed herein, and allow the user to copy the code examples into his own codebase through the use of the editor 302.

### A. Dynamic Code Examples

In an embodiment, programming co-pilot system 340 includes a dynamic code example execution system 342.

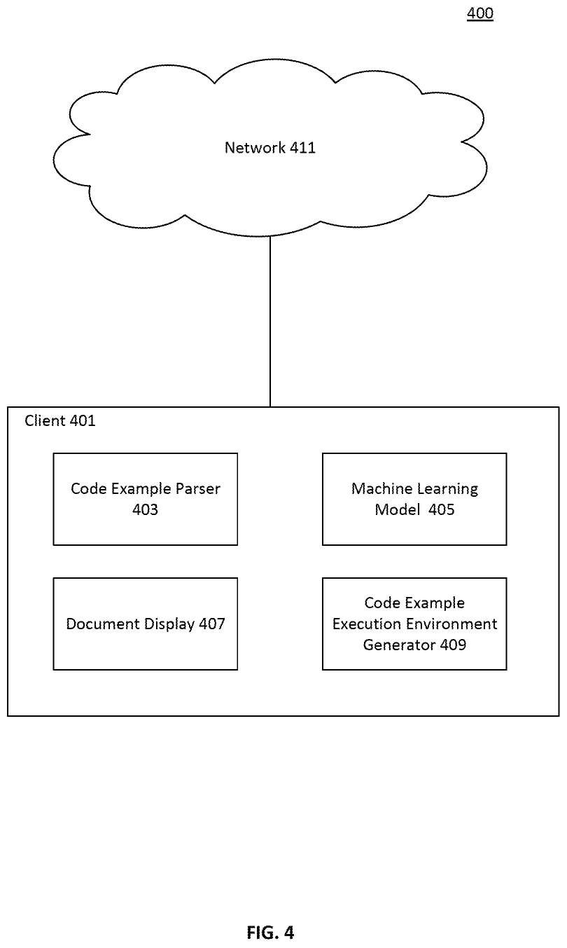

FIG. 4 illustrates an example dynamic code example execution system 400 according to an embodiment. Client 401 may be a client such as client 130, for example. Client 401 may connect to various resources via network 411 which may be a network such as network 140. For example, document display 407 may be a web browser which connects to web pages via network 411 and displays rendered web pages on client 401. Code example parser 403 may be a software component running on client 401 which parses pages displayed by document display 407 to identify code examples that are displayed on client 401. In an embodiment, code example parser 403 may be a web browser extension, for example, running in conjunction with a web browser document display 407. In other embodiments, code example parser 403 may be executed independently of a web browser.

Code example execution environment generator 409 may be a software component running on client 401 which generates and configures execution environments for code examples. Code example execution environment generator 409 may be separate from or a part of code example parser 403 in some embodiments. In some embodiments, various aspects of code example parser 403 may utilize machine learning model 405 which is a machine learning model such as machine learning model 200.

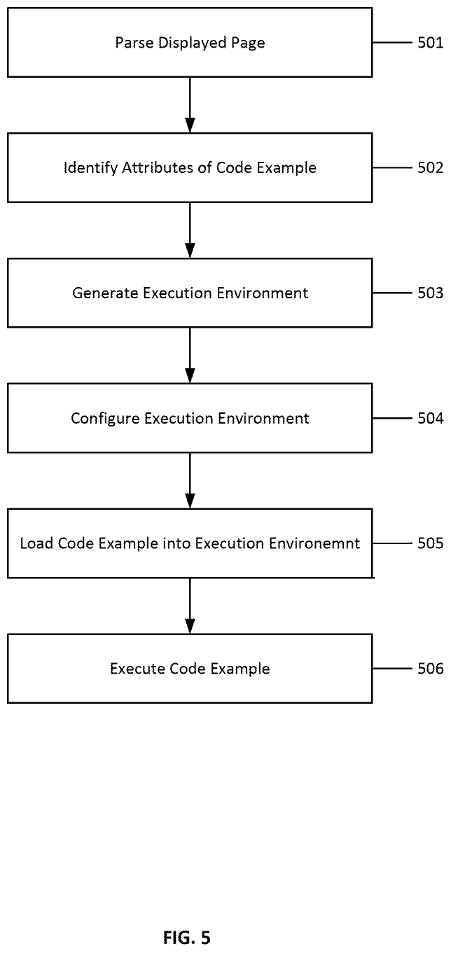

FIG. 5 illustrates the steps of a method of dynamically executing code examples according to an embodiment. For example, a dynamic code example execution system such as dynamic code example execution system 400 may be used to dynamically execute code examples. At step 501, a displayed page is parsed to identify a code example using a code example parser such as code example parser 403, for example.

A displayed page may be a web page comprising HTML elements, a PDF document, a text document encoded in a markup language such as markdown, an XML document, or any other such structured text document. In an embodiment, code example parser 403 may be a web browser extension, for example. Code examples may be identified based on structured text tags. For example, in a displayed web page that comprises HTML elements, a code example may be identified as a block or blocks of text that are enclosed in HTML tags such as <pre> or <code>. In some embodiments, code examples may be identified based on heuristic models or by using a machine learning model to identify executable code examples in a displayed page.

At step 502, the displayed page is further parsed to identify attributes of the code example identified in step 501. Attributes of the code example may include any information necessary to execute the code example. Attributes may include, for example, the programming language that the code example is written in, an identification of a software package dependency or reference that the code example requires to run, an operating system, and other aspects of the runtime environment that is necessary for the code example to run such as but not limited to an identification of a file system type, any environment variables that need to be set, or other software that the code examples interfaces with such as a database system or remotely accessed resource.

Code example attributes may be parsed from or inferred from any part or portion of the displayed page. For example, a title of the displayed page, displayed text on the displayed page, text in the markup of the displayed page that is not displayed such as metadata or markup tags, and tags displayed on the displayed page may be sources of attributes of the code example.

In some embodiments, attributes may be identified based on rules or heuristics that define various aspects or attributes of a code example. For example, a set of rules may be provided for identifying a programming language of the code example that includes a set of programming languages to identify in the displayed page.

In an embodiment, attributes of the code example may be identified by a machine learning system such as machine learning system 405. For example, a training corpus of code examples and their attributes may be used to train a machine learning system to identify relevant attributes on a displayed page.

In some embodiments, the content of the identified code example may be analyzed and parsed to determine an attribute of the code example. For example, a static analysis of the code example may be performed to identify a programming language that the code example is written in. In another example, a reference to a software library or package in the code example may be a source of an inference that the software library or package is required to execute or run the code example. In some embodiments, a machine learning system such as machine learning model 405 may be used to identify attributes based on the content of a code example.

At step 503, an execution environment for the code example is generated by an execution environment generator such as execution environment generator 409. Attributes identified in step 502 may be related to a type of execution environment that the code example requires for execution. For example, an attribute of the code example may specify a programming language that the code example is written in, and an execution environment for executing the code example may be generated for executing code written in that programming language. Other attributes may be used to generate an execution environment as well, such as an identification of an operating system or a version of a programming language that the code example is dependent on. As an example, a code example may require the Python 2.X programming language to be installed and configured on a Debian Linux operating system for execution, as specified by various attributes identified in step 502.

An execution environment for the code example may include, for example, a virtual machine, a containerized computing environment such as a Docker container, a language-specific virtual environment such as a Python virtual environment, or other such isolated computing environment that may enable the execution of the code example. In an example, a code interpreter may be generated as an execution environment such as a Node.js runtime for JavaScript which may not necessarily require isolation as provided by a containerized or virtualized computing environment.

In some embodiments, a containerized execution environment may be generated for executing a code example. For example, a container specification such as a Dockerfile may be generated which specifies a base Docker image for executing a code example. In an example, a Dockerfile may specify a particular operating system image that includes a general execution environment for a programming language such as Python.

In some embodiments, a virtual machine runtime environment may be generated for executing a code example. A virtual machine may be selected from a repository of virtual machine images that contains an execution environment for a particular programming language, for example.

In some embodiments, an execution environment for the code example may be directly generated by the execution environment generator in step 503. In some embodiments, the execution environment generator may generate a specification or recipe for creating the execution environment by another tool. For example, in some embodiments, the execution environment generator may generate a Dockerfile for specifying a Docker image, a set of instructions for an orchestration platform such as Kubernetes, a set of instructions for a configuration management platform such as Puppet, Chef, Ansible, or Salt, or a set of instructions for configuring a virtual machine platform such as VMWare ESXi, Hyper-V, QEMU, KVM, or the like. In these embodiments, the execution environment generator may generate a set of instructions and transmit the set of instructions to a separate system for executing the set of instructions to generate the execution environment.

At step 504, the execution environment generated in step 503 is configured according to the attributes and parameters identified in step 502. Configuration steps may include setting certain variables or attributes of the execution environment or installing dependencies in the execution environment, for example. If an attribute of the code example specifies a dependency of the code example, any package dependencies may be installed or otherwise configured in the execution environment as specified by attributes identified in step 502. For example, a software package dependency may be installed in a virtual machine image. In another example, a Python module dependency may be installed in an execution environment. In some embodiments, a package manager may be used to configure an execution environment, such as using the Pip package management system for Python to configure a Python dependency. As another example, the npm package manager may be used to install and configure dependencies in a Node.js JavaScript execution environment. In some embodiments, configuration steps may include configuring the file system structure and files in the file system. For example, files and directories may be created, modified, or deleted so that a code example that depends on a specific file structure or files may be run.

In an example embodiment, a database system may be specified and configured to enable a code example to execute. For example, a relational database such as SQLite, MySQL, or PostgreSQL may be specified by a database version, database tables, other database parameters such as stored procedures, and a set of seed data to enter into the database once it is generated. A non-relational data store may be specified such as MongoDB, Cassandra, Redis, or the like. Non-relational data stores may similarly be configured with seed data for execution of a code example. In addition, a software development framework may be installed and/or configured for execution of a code example. For example, a web development framework such as Django or Rails may be specified.

In an example embodiment, the configuration steps include setting up a running process, separate from the code example to communicate with the code example. The running process may provide inputs to the code example or accept output from the code example. Communication may occur through, for example, interprocess communication, pipes, files, semaphores, message queues, databases, and other communication channels. Configuration of the process may include choosing the process to run, such as by file name, and choosing parameters for the running process, such as command line options or other settings.

In some embodiments, configuration of the execution environment may be performed directly on the execution environment such as in the examples above. In some embodiments, configuration of the execution environment may include generating or modifying a specification for the execution environment. For example, a Dockerfile may be edited or modified to configure a Docker execution environment. Similarly, any specification or recipe for creating the execution environment by another tool may be modified to configure the execution environment according to the attributes of the code example.

Other configuration parameters of an execution environment may be set, such as operating system environment variables, database connection strings, input files, or the like. In addition, other software packages may be specified such as web server packages, in-memory data caches, or other executable software that the code example relies upon for execution. For example, a command-line accessible tool such as an image processing program may be configured in an execution environment for a code example to execute.

At step 505, the code example is loaded into the configured execution environment. Depending on the type of execution environment, the code example may be loaded into the configured execution environment a variety of different ways. For example, the code example may be copied to a file in a virtual machine execution environment. As another example, a code example may be copied to a file and the file included in a container specification such as a Dockerfile. In yet another example, a reference to the code example may simply be passed to an execution environment such as a JavaScript execution environment that is not encapsulated in a virtual machine, a container, or other such isolation mechanism.

At step 506, the code example is executed or run in the configured runtime environment. For example, a Docker container may be run, a virtual machine started, or a command to execute the code example issued to a programming language runtime. The output of the code example may be captured and stored in file or displayed in a user interface element.

### B. Configuration of Custom Environments

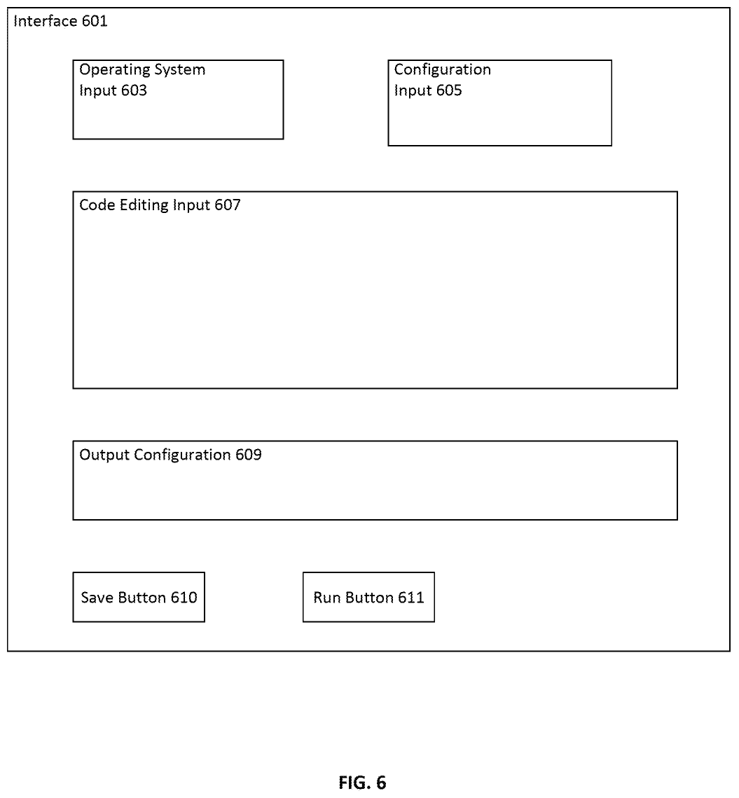

In some embodiments, a dynamic code example execution system 342 may allow for a code example and/or a code execution environment to be edited and changed prior to execution. FIG. 6 illustrates an example user interface of an editable dynamic code example execution system according to an embodiment. Interface 601 may be an interface of a client such as client 401, for example. Interface 601 may be, for example, a graphical user interface of client 401. Interface 601 provides for several interface elements for configuring and editing a code example and a code example execution environment.

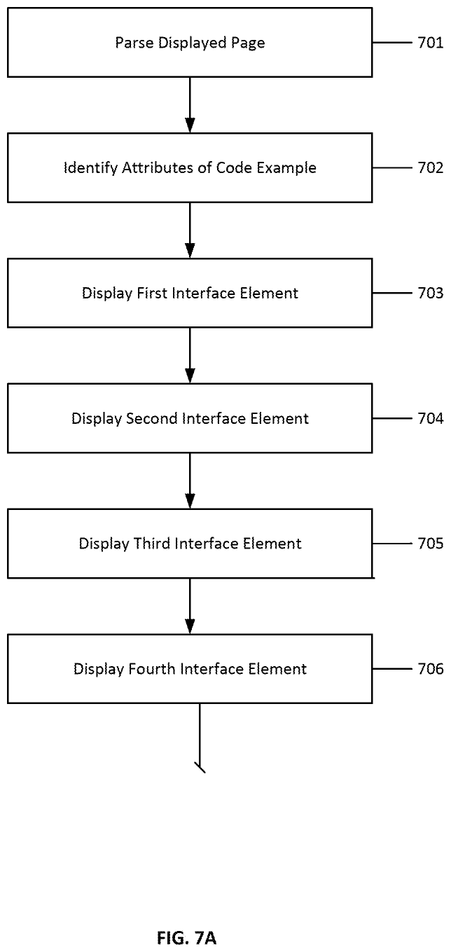

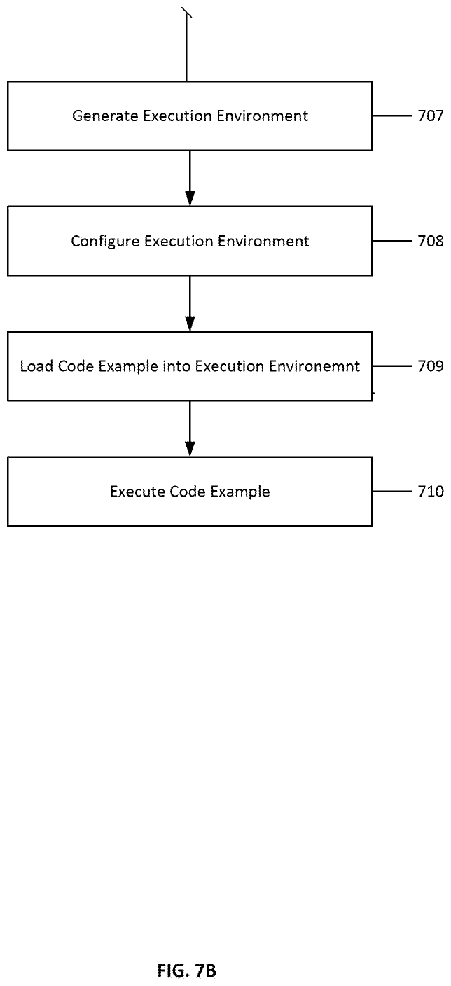

Operating system input 603 allows for the specification of an identity of an operating system and one or more dependencies for running the code example. Configuration input 605 allows for the configuration of an operating system environment for running the code example. Code editing input 607 allows for the editing of the content of the code example. Output configuration 609 allows for configuring the output of the code example. Save button 610 allows saving the code example to a database, such as code examples database 1101. In some embodiments, the save button may also share the code example to an online community of code examples. Run button 611 allows running the code example. Operation of these interface elements and more is described in connection with FIGS. 7A-B, below.

FIGS. 7A-B illustrates the steps of a method of editing and dynamically executing code examples according to an embodiment. At step 701, a displayed page is parsed to identify a code example in a similar way as step 501 of FIG. 5. At step 702, the displayed page is further evaluated to identify attributes of the code example similar to step 502.

At step 703, the code example execution system displays a first interface element for allowing the specification of an identity of an operating system and one or more dependencies for running the code example. In an embodiment, the first interface element is pre-populated with values for selection based on the attributes identified in step 702. Any operating system specification or dependencies such as described above in connection with FIG. 5 may be received by the first interface element. For example, an operating system such as Ubuntu may be specified, as well as a set of required packages installed on the operating system such as a database such as SQLite, a code runtime such as Python, and a framework such as Django.

Selection of the aforementioned options may be made by various user interface elements. In some embodiments, the options may selected from a collection of approved values through a drop-down menu or may be selected through text entry into a search box, which causes a search through a list of approved values. In other embodiments, the options may be entered through free text input. These methods of user selection may also used for any other user selection events herein.

At step 704, the code example execution system displays a second interface element for allowing the configuration of an operating system environment for running the code example. In an embodiment, the second interface element is pre-populated with values for selection based on the attributes identified in step 702. Any configuration such as described above in connection with FIG. 5 may be a configuration that may be received by the second interface element. In addition, other configuration values or parameters may be specified by the second interface element. For example, an external service or system may be specified that the code example interfaces with or relies on. As an example, an HTTP request may be specified to be sent to or submitted to the code example for its execution. As another example, a specification of database tables and a collection of seed data may be specified for the code example to operate on.

At step 705, the code example execution system displays a third interface element for allowing editing of the code example. The code example editing interface may include code editor features such as but not limited to code highlighting, autocompletion, interactive execution, refactoring suggestions, code navigation tools, and other such code editor features. The code example may be edited and executed dynamically within the interface.

At step 706, the code example execution system displays a fourth interface element for configuring the output to be displaying based on the running of the code example. The output configuration may include displaying shell output of an execution environment, data elements of a database as manipulated by the code example, features of a client such as an HTTP client that interact with the code example, and other such outputs of the execution of a code example. In an embodiment, the fourth interface element comprises at least an option for displaying STDOUT and at least an option for displaying STDERR.

In another example, an HTTP client may display portions of an HTTP response returned by the code example, such as HTTP header information of an HTTP response generated and returned by the code example. In some embodiments, an output of a code example may be processed or filtered for display. For example, a JSON response or output of a code example may be formatted and displayed in a way to facilitate easy viewing of the JSON data such as including highlighting, indentation, and navigational aids such as section collapsing. In some embodiments, an output of the code example may be rendered by a rendering system and a display of the rendered output included in the output. For example, a code example that renders a graphical output plot may include rendering instructions to render the plot to an image and include that image in the output display of the code example. In another example, a sequential output of a code example may be displayed or played in an output when a code example specifies a sequential transformation of an object.

At step 707, an execution environment for the code example is generated by an execution environment generator similar to step 503 of FIG. 5. Parameters and attributes for the generation of the code execution environment may be received from input into the first user interface element or determined from attributes identified in the displayed document. At step 708, the execution environment is configured similar to step 504 of FIG. 5. Parameters and attributes for configuring the execution environment may be received from the second user interface element or from attributes identified in the displayed document. At step 709, the code example is loaded into the configured execution environment similar to step 505 of FIG. 5. The code example may be modified as indicated in the input from the third user interface element or the code example may be executed unmodified. At step 710, the code example is executed or run in the configured runtime environment similar to step 506 of FIG. 5. An output from the code example may be processed or displayed according to instructions or configurations as specified in the fourth user interface element. The output of the code example may be captured and stored in file or displayed in a user interface element.

### C. Specification Files for Storing Custom Environments

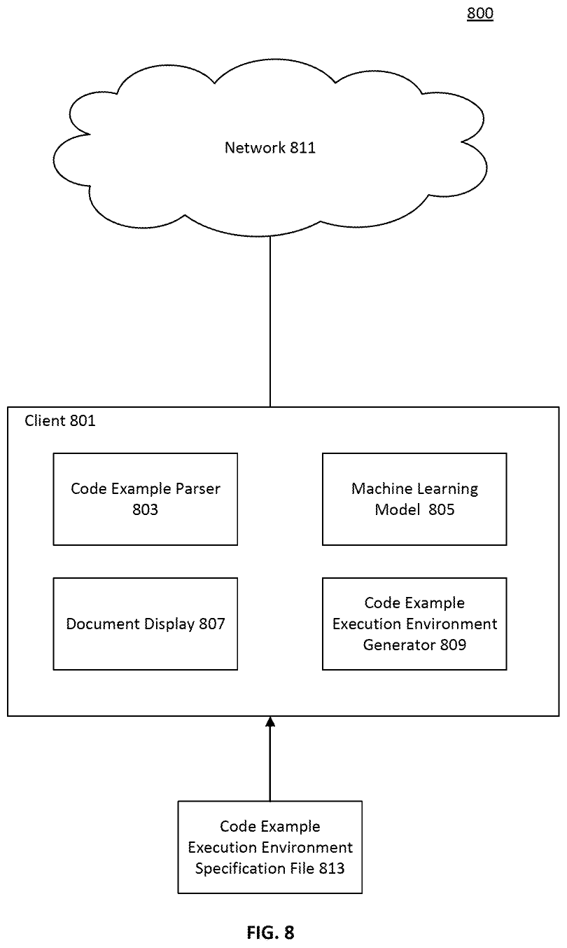

In some embodiments, a specification file may be supplied to a code example execution system that specifies one or more parameters or attributes of a code example execution environment. FIG. 8 illustrates an example system diagram of a dynamic code example execution system according to an embodiment. Client 801 may be a client such as client 401 or 130, for example. Client 801 may connect to various resources via network 811 which may be a network such as network 140 or 411, for example. For example, document display 807 may be a web browser which connects to web pages via network 811 and displays rendered web pages on client 801. Code example parser 803 may be a software component running on client 801 which parses pages displayed by document display 807 to identify code examples that are displayed on client 801. In an embodiment, code example parser 803 may be a web browser extension, for example, running in conjunction with a web browser document display 807. In other embodiments, code example parser 803 may be executed independently of a web browser.

Code example execution environment generator 809 may be a software component running on client 801 which generates and configures execution environments for code examples. Code example execution environment generator 809 may be separate from or a part of code example parser 803 in some embodiments. In some embodiments, various aspects of code example parser 803 may utilize machine learning model 805 which is a machine learning model such as machine learning model 200.

Code example execution environment specification file 813 is a collection one or more attributes including an identity of an operating system and one or more dependencies for running the code example and a set of configuration values of an operating system environment. Code example execution environment specification file 813 may be received from a user input, from a network resource, or other source. Code example execution environment specification file 813 may be specified or formatted in a format such as JSON, YAML, XML, or other such similar structured text format.

In an embodiment, code example execution environment specification file 813 may reference a template code example execution environment specification file. For example, a code example execution environment specification file may be referenced by an identifier, and the contents of the referenced code example execution environment specification file used as a base for code example execution environment specification file 813. If no additional parameters or attributes are specified in code example execution environment specification file 813, the referenced code example execution environment specification file may be used in its entirety. If additional attributes or parameters are specified in code example execution environment specification file 813, those additional attributed or parameters may be appended to or overwrite portions of the referenced code example execution environment specification file to produce a new code example execution environment specification file. In this way, template or stock code example execution environment specification files may be reused and modified for new applications.

In an embodiment, code example execution environment specification file 813 may include three sections. A first section may specify an operating system and dependencies required to execute the code example. A second section may specify a file system structure, other process dependencies, data files referenced by the code example, database contents expected by the code example, identification of external resources referenced by the code example, and other such configuration and dependency information required to execute the code example. A third section may include the code of the code example itself, or a reference to a file containing the code of the code example. A fourth section may specify options for capturing the output of the code example, such as which output channels to capture, including STDOUT, STDERR, and so on.

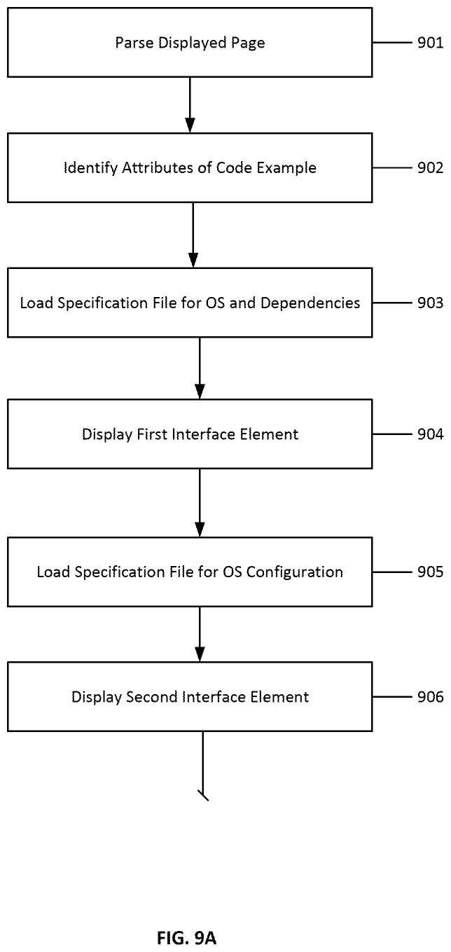

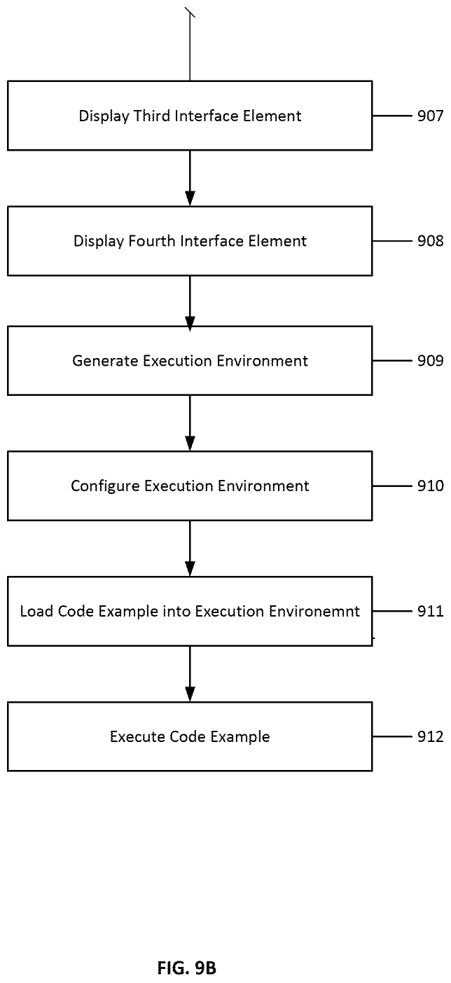

FIG. 9 illustrates the steps of a method of editing and dynamically executing code examples according to an embodiment. At step 901, a displayed page is parsed to identify a code example in a similar way as step 501 of FIG. 5. At step 902, the displayed page is further evaluated to identify attributes of the code example similar to step 502 of FIG. 5.

At step 903, the code example execution system loads a specification file including one or more attributes identifying an operating system and one or more dependencies for running the code example. The specification file may be a code example execution environment specification file such as code example execution environment specification file 813. The one or more attributes identifying an operating system and one or more dependencies for running the code example may include any examples of attributes identifying an operating system and one or more dependencies for running a code example such as discussed above in connection with FIGS. 5-7.

The attributes identified in step 902 and the attributes loaded from the specification file 903 may be merged in various ways. In one embodiment, the attributes identified in step 902 take precedence and, in another embodiment, the attributes loaded from the specification file take precedence. In another embodiment, all attributes from both steps are loaded. Alternatively, all attributes are loaded from both steps but, for conflicting attributes, one or the other takes precedence. In yet another approach, all attributes are loaded from both steps, but the system displays the conflicting attributes to the user and accepts input from the user selecting which attribute should be chosen from between the conflicting options.

At step 904, the code example execution system displays a first interface element pre-populated with the one or more attributes identifying an operating system and one or more dependencies for running the code example loaded from the specification file in step 903 or inferred in step 902. The first interface element is editable and allows for editing the identity of the operating system and one or more dependencies for running the code example. The first interface element may be an interface element such as operating system input 603 of interface 601 as described in connection with FIG. 6, above.

At step 905, the code example execution system loads a specification file including one or more configuration values of an operating system environment. The specification file may be the same or a different specification file as loaded in step 903.

At step 906, the code example execution system displays a second interface element for allowing the configuration of an operating system environment for running the code example. The second interface element may be an interface element such as configuration input 605 of interface 601 as described in connection with FIG. 6, above. The configuration of an operating system environment for running the code example may include any examples of configuration of an operating system environment for running the code example such as discussed above in connection with FIGS. 5-7. The second interface element may be pre-populated by attributes identified or loaded during steps 902 or 903. Precedence between the two steps may be determined using methods described herein.

At step 907, the code example execution system displays a third interface element for allowing editing of the code example. The third interface element may be an interface element such as code editing input 607 of interface 601 as described in connection with FIG. 6, above.

At step 908, the code example execution system displays a fourth interface element for configuring the output to be displaying based on the running of the code example. The fourth interface element may be an interface element such as output configuration 609 of interface 601 as described in connection with FIG. 6, above. The output configuration parameters or attributes may include any examples of output configuration parameters or attributes such as discussed above in connection with FIGS. 5-7. The second interface element may be pre-populated by attributes identified or loaded during steps 902 or 903. Precedence between the two steps may be determined using methods described herein.

At step 909, an execution environment for the code example is generated by an execution environment generator similar to step 503 of FIG. 5. Parameters and attributes for the generation of the code execution environment may be received from input into the first user interface element or loaded from the specification file. At step 910, the execution environment is configured similar to step 504 of FIG. 5. Parameters and attributes for configuring the execution environment may be received from the second user interface element or loaded from the specification file. At step 911, the code example is loaded into the configured execution environment similar to step 505 of FIG. 5. The code example may be modified as indicated in the input from the third user interface element or the code example may be executed unmodified. At step 912, the code example is executed or run in the configured runtime environment similar to step 506 of FIG. 5. An output from the code example may be processed or displayed according to instructions or loaded from the specification file.

### D. Sandboxed Execution

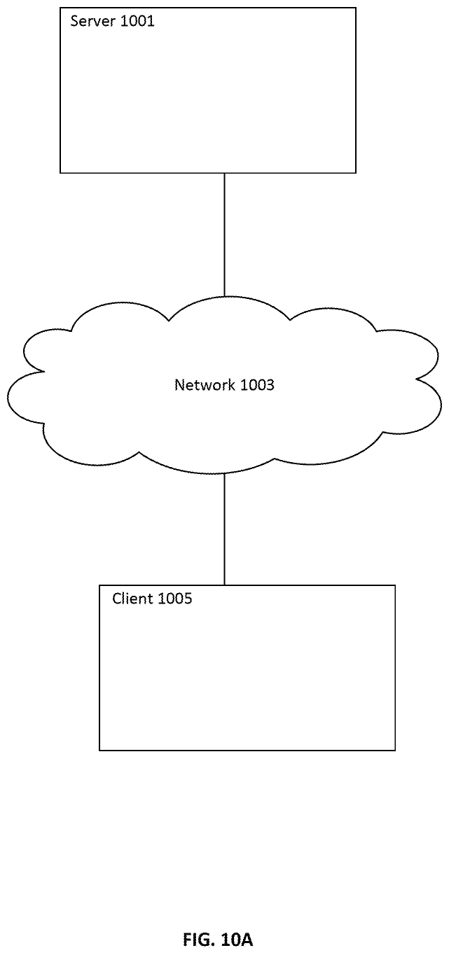

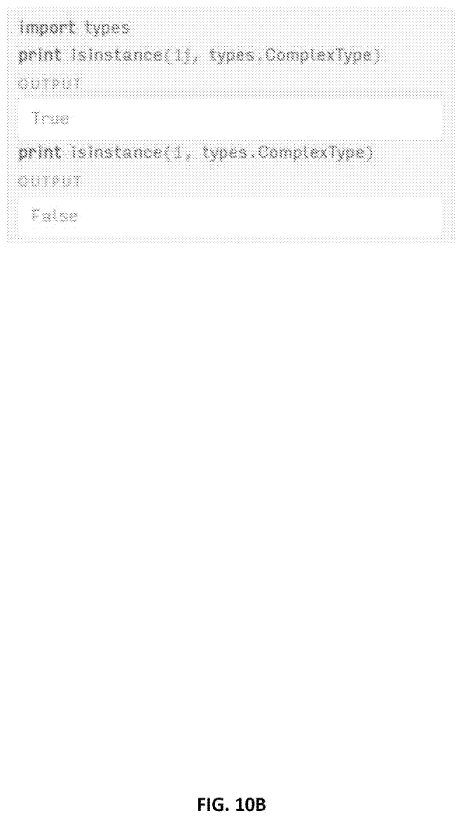

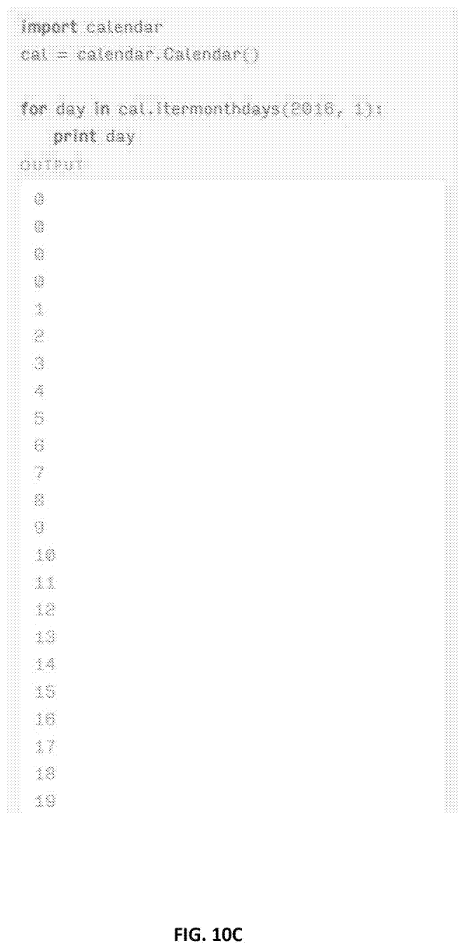

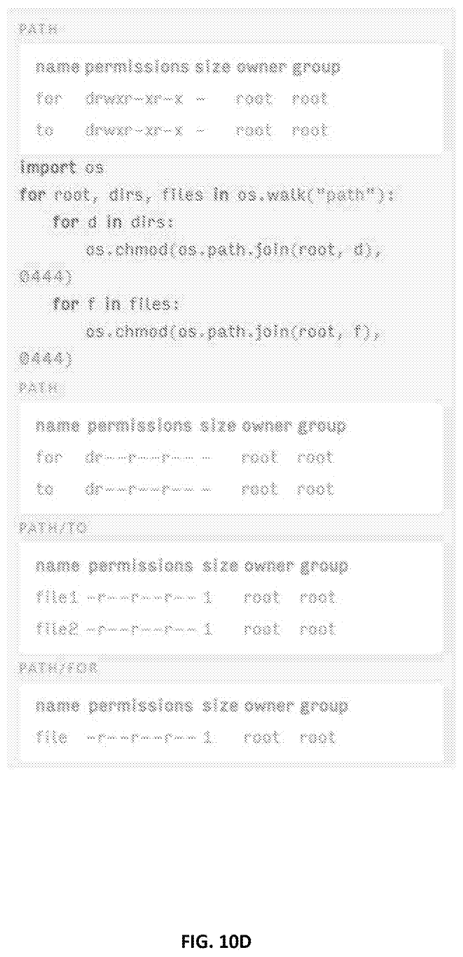

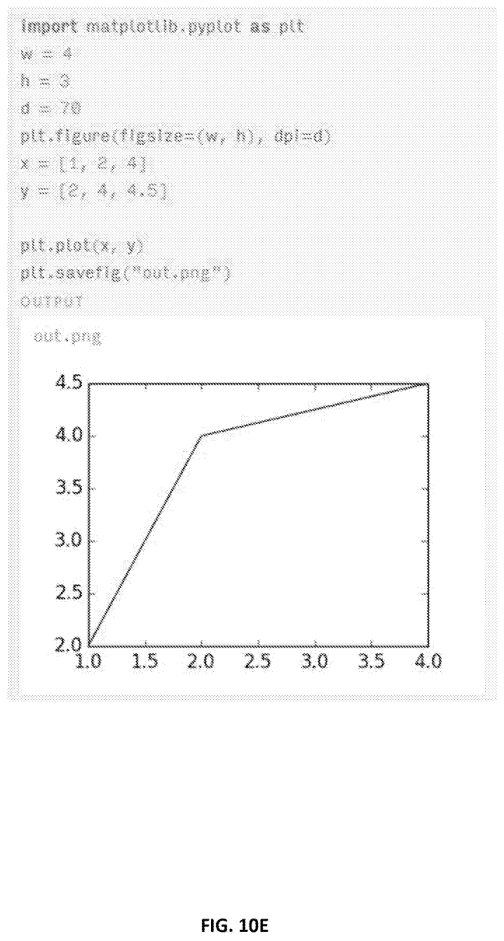

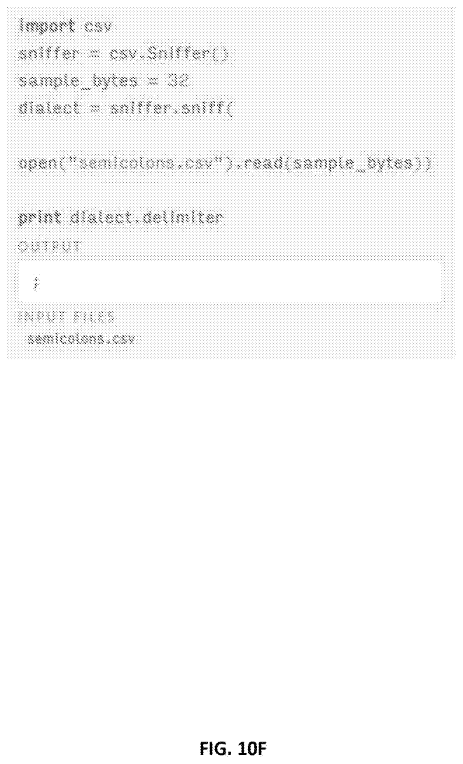

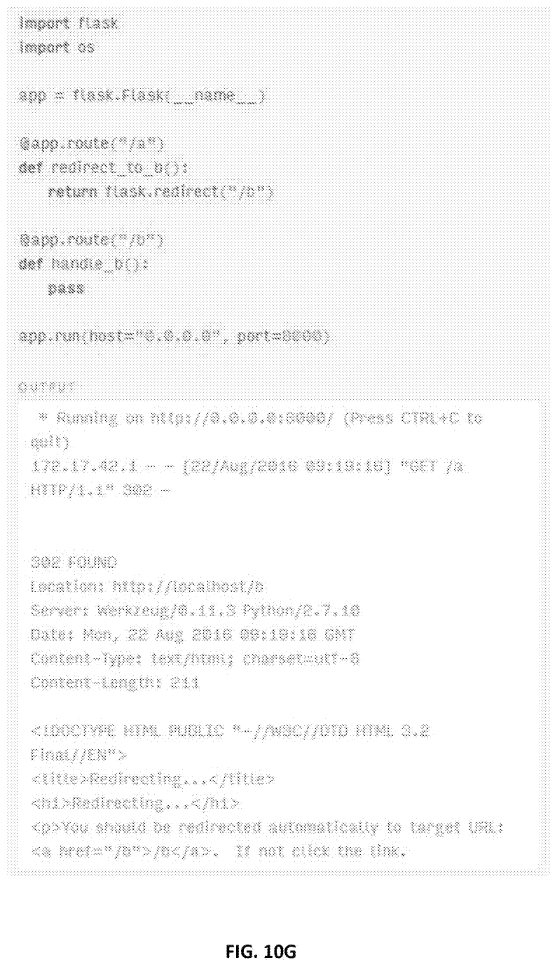

In some embodiments, a code example is executed in an execution environment on a remote computing platform. FIG. 10A illustrates a code example execution environment according to an embodiment. Client 1005 is a client that operates a code example execution system according to one of the embodiments disclosed above. When client 1005 executes a code example, it may transmit the code example and a code execution environment specification via network 1003 to server 1001. Server 1001 then generates and configures a code example execution environment according to the received specifications and executes the code example. For example, server 1001 may generate a container image, virtual machine, or other code execution environment to execute the code example. Results of the code example execution are then transmitted back to claim 1005 via network 1003.

### E. Code Example Execution Features

In some embodiments, code examples may include one or more features related to their display or execution.

FIG. 10B illustrates an exemplary code example with the output of the code example interleaved with the code of the code example. In an embodiment, the code example may be run in the execution environment and the output captured. The captured output may be associated to the line of code that caused the output. The output may then be displayed in correspondence with the line of code, such as below, above, next to, or near the line of code, to indicate the line of code caused the output. In some embodiments, the line of code that caused the output may a regular print or output command, rather than a special command for causing interleaving of the output with the code.

FIG. 10C illustrates an exemplary code example where a single line of code is executed more than once, as the inside of the for loop is in this example. In an embodiment, each of the lines of output from multiple executions of a single line of code may be grouped and displayed together as shown in FIG. 10C. In one embodiment, the system detects if a line of code is executed once or more than once, and if the line of code is executed more than once then it displays all the output of that line of code at the end of the code example, instead of inline. In some embodiments, interleaving the output when a line of code is executed more than once may be difficult to interpret for a user. In one embodiment, if any line of code in the code example is executed more then once, then output interleaving is turned off and the output is displayed in a single segment, such as at the end of the code example. In an alternative embodiment, if any line of code in the code example is executed more than once, then only the output from that line of code is grouped together and displayed in a single segment, such as a the end of the code example.

FIG. 10D illustrates an exemplary code example where one or more special commands are entered in the code example to request the system to render a file system listing. For example, the embodiment shows commands “PATH”, “PATH/TO”, and “PATH/FOR”. FIG. 10E illustrates another code example where the special commands are for display of a file or image. In FIGS. 10D-E, the output of these commands is shown in the display. The commands may be transmitted to the execution environment for execution. In an embodiment, the system parses the code example and detects the special commands when it is displaying the code example. The system may strip out the special commands and their output when displaying the code example, either in all modes or in certain modes such as a default mode. In that case, the commands are not rendered as part of the code example. The commands may be entered in a code editing environment, in a specification file, or in other environments. In one embodiment, the commands may be entered in the code editor where regular code is being entered, even though the commands are not regular code for the code base.

In an embodiment, the code examples may allow the ability to hide code when the code example is displayed. The code may be hidden in all modes or in certain modes, such as a default mode. In an embodiment, hidden code may be delimited with one or more characters such as “##” to indicate that the code should be hidden from display or rendering. In one embodiment, special commands in the code example are preceded by one or more characters indicating to hide the code. This will then cause the special commands to not be displayed.

FIG. 10F illustrates an exemplary code example where the user has specified an input file. In this embodiment, the input file may be added to the execution environment of the code example before the code example is run. In the example, the code example refers to the input file “semicolons.csv” so adding the file to the execution environment will allow the code example to find and load the input file. The identity or name of the input file may be entered in a code editing environment, in a specification file, or in other environments.

FIG. 10G illustrates an exemplary code example where the execution environment transmits a network request to the running code example. For example, if the code example demonstrates an HTTP server, the execution environment may make an HTTP request to the running code example and render the output. The execution environment may generate the network request and pass it to the running code example through one or more input channels of the running code example. The output of the code example may be displayed as illustrated in FIG. 10G.

### F. Community for Code Example Sharing

In some embodiments, code examples may be indexed and shared among a group of users. In some embodiments, code example execution may be reported to a centralized repository for tracking code example execution, operation, and user response.

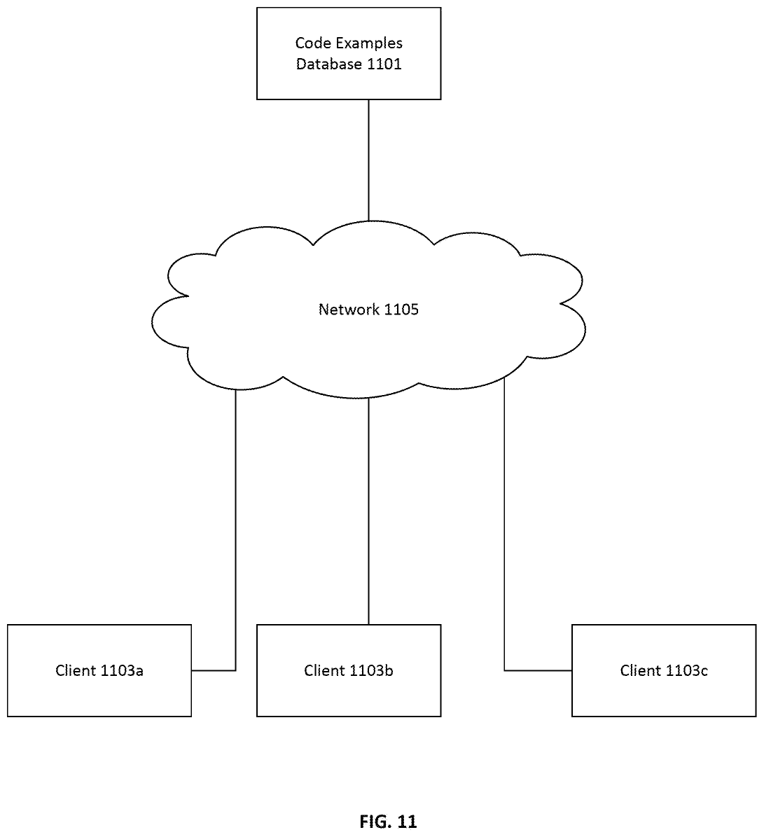

FIG. 11 illustrates a code example sharing community according to an embodiment. Clients 1103a-c are code example execution clients that operate a code example execution system according to one of the embodiments disclosed above. When a code example execution client 1103 executes a code example, it may report the code example and other reporting information via network 1105 to code examples database 1101.

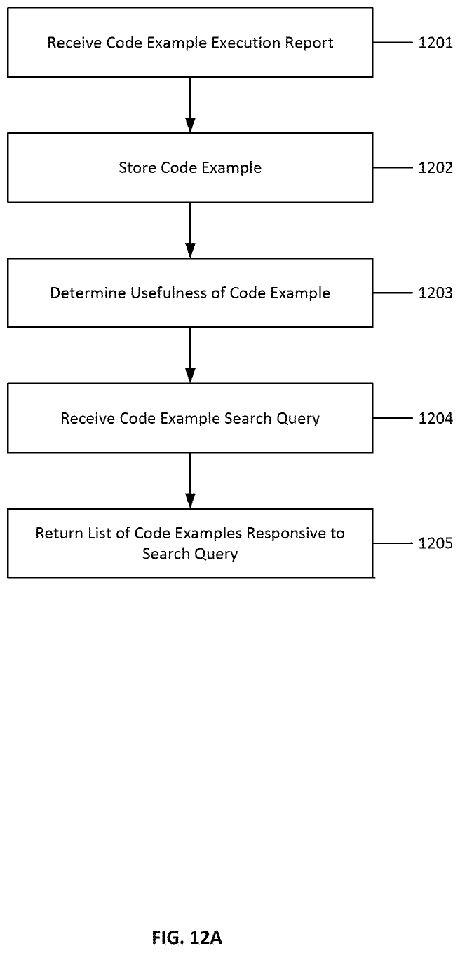

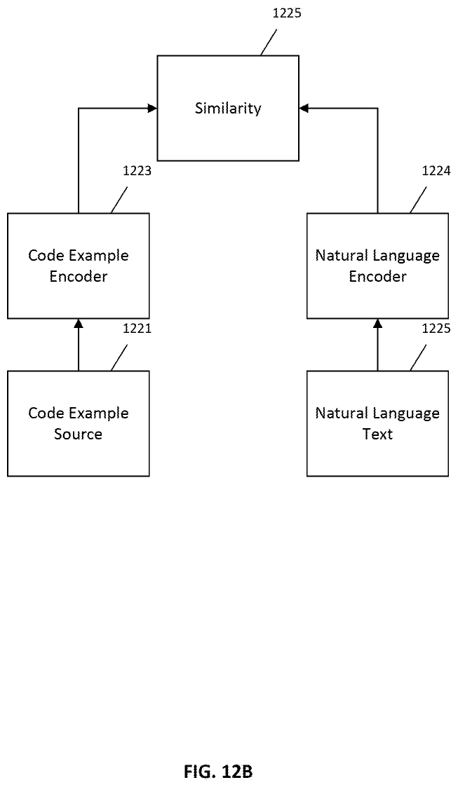

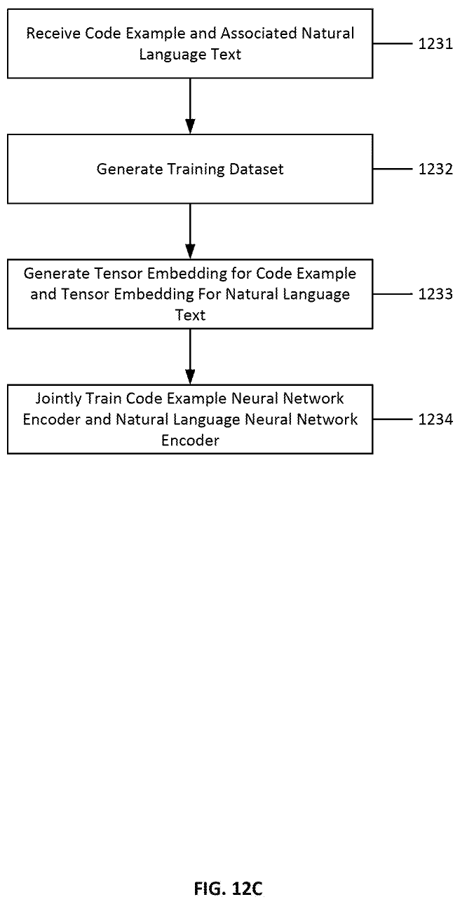

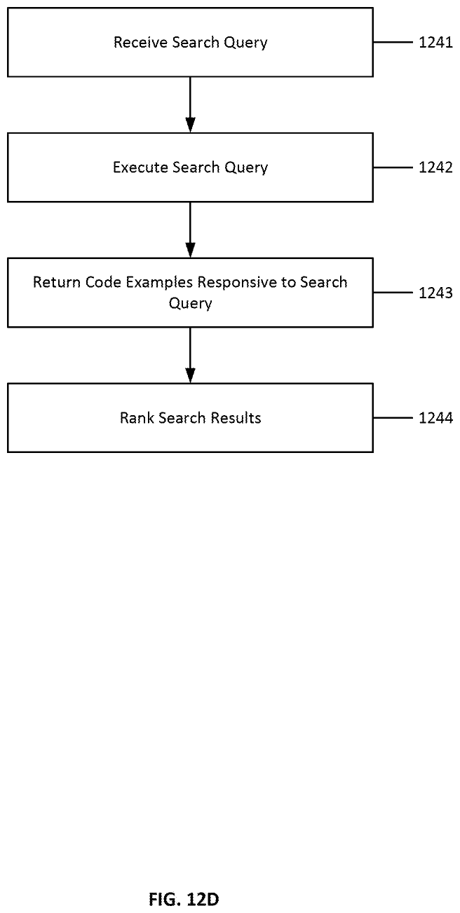

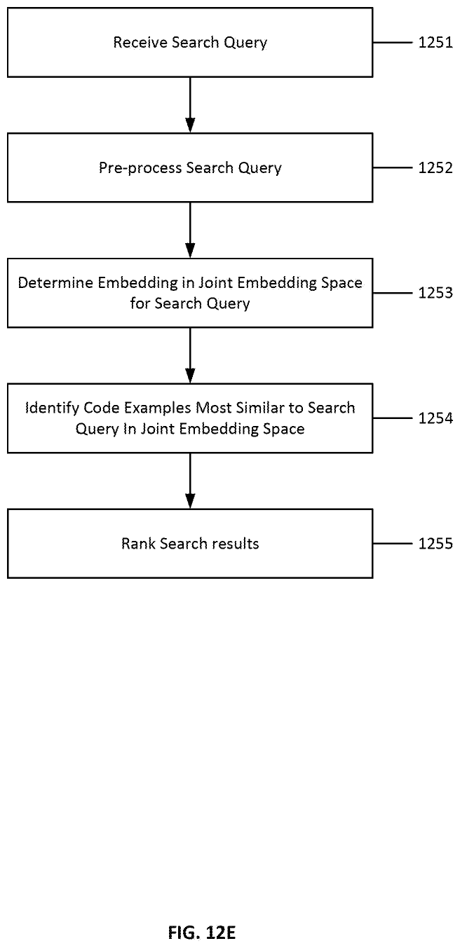

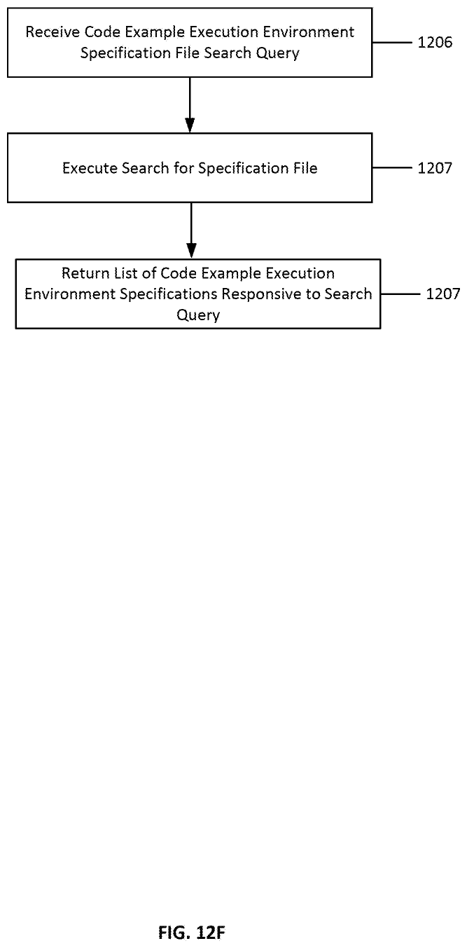

FIG. 12A illustrates the steps of a method for sharing code examples according to an embodiment. At step 1201, a code examples database receives a report of an execution of a code example. A report may include the content of the code example, a reference to the source of the code example, a list of attributes used to execute the code example, a specification file specifying an environment for executing the code example, a user rating of the code example, or other such reporting metrics.

At step 1202, the received code example and reporting information is stored in the code examples database. The code examples database includes a plurality of code examples and execution reports that are aggregated with the code example and reporting information.

At step 1203, a usefulness score of the code example is indexed by the code examples database. Code examples may be indexed according to any parameter of the code example, such as but not limited to a programming language of the code example, a source of the code example, an execution environment attribute of the code example, a dependency of the code example, a user rating of the code example, a number of views of the code example, a number of edits of the code example, and a number of executions of the code example. A rating of the code example may be comprised of any rating system, such as but not limited to a number of stars rating system or a thumbs up or down rating system. Any measure or proxy of usefulness or helpfulness of the code example may be received, measured, and indexed by the code examples database so that code examples may be easily discovered by others. A source of the code example may be used as a proxy for usefulness. For example, a code example from a web page that includes implicit or explicit ratings or user engagement metrics may serve as a proxy for a usefulness of the code example. As an example, code examples sources from pages on sites such as StackOverflow or GitHub may incorporate ratings, upvotes, number of user responses, or any other such implicit or explicit measure of usefulness of the code example as a factor in indexing code examples. Similarly, code examples sourced from official sources such as the author or maintainer of a code example may be determined to have a higher usefulness score.

Code examples in the code examples database may be segmented according to a particular technology, dependency, or other feature of the code examples. For example, all code examples relating to a particular web framework such as Django may be associated and indexable by their relation to Django. Code examples may also be grouped by keywords and topics inferred from the displayed pages on which they are found. Keywords and topics may be inferred by a number of mechanisms.

In some embodiments, keywords are extracted from text using a statistical approach. For example, a word frequency statistic may be used to identify and extract keywords from a text document. All words of a document may be counted and indexed, and a top number or percentage of all unique words in the document may be selected as keywords. Common words such as conjunctions and articles may be omitted from frequency analysis to better isolate words having more semantic meaning. In some embodiments, a fixed dictionary of words may be omitted from analysis, and in other embodiments a machine learning approach may be used to identify common words to be omitted from frequency or statistical analysis.

The structure of a document may contain information that may be used to identify keywords of a text document. For example, if the document is encoded in a markup language such as HTML, markup tags associated with the readable text of the document may be used as hints or indicators of important words that may be identified as keywords. In HTML, for example, a heading tag may be an indicator that the text contained in the heading is representative of a high-level concept that surrounding text is related to. Similarly, bulleted or numbered lists may indicate portions of text that encapsulate the meaning of nearby text.

In some embodiments, keywords may be extracted from text based on the linguistic properties of words and sentences in the text. For example, words in a text may be identified by their grammatical properties and then certain classes of words may be selected as keywords or for further keyword analysis. In an embodiment, words in a text are tagged by a parts of speech tagger. Words that are tagged as the same part of speech have similar syntactical behavior within the grammatical structure of sentences. For example, common English parts of speech include nouns, verbs, adjectives, adverbs, pronouns, prepositions, conjunctions, interjections, among others. Words may further be tagged, grouped, or classified based on their relationship with adjacent and related words in a phrase, sentence, or paragraph. For example, portions of sentences may be tagged with identifiers such as subject, object, adverbial, or verb, among others. Keywords may then be identified from a text using this grammatical and linguistic information. For example, proper nouns may be selected as candidates for keyword extraction as they may identify specific topics or concepts that are closely related to the semantic meaning embodied by the text.

In some embodiments, any of the above approaches or methods may be implemented as a set of rules or heuristics applied to the associated text sources. These rules or heuristics may be represented in a decision tree format, for example. In addition, implementations of these approaches may be combined together. For example, a rules-based approach may use linguistic features to identify keyword candidates, and then use a statistical approach to select a subset of the keyword candidates as final keywords for a document.

In some embodiments, a machine learning model may be trained to determine keywords of a document. For example, a neural network may be trained to identify and extract keywords from documents. A machine learning model may also be combined with a rules-based keyword extraction approach as well. For example, a set of rules-based keyword extraction methods may be used to pre-process the text of a document before it is analyzed by a machine learning model.

Code examples may also be grouped by using embeddings in a joint embedding space. Embeddings may be assigned to code examples based on the content in the code example or text content displayed on a page that includes the code example. Code examples may be grouped by applying a similarity metric based on the embeddings and grouping code examples that are close together in the joint embedding space.

FIG. 12B illustrates a machine learning network 1220 for code example grouping according to an embodiment. Code example encoder 1223 generates a tensor embedding in a joint tensor space for an input code example 1221. Natural language encoder 1224 generates a tensor embedding in the same joint tensor space for input natural language text 1222. The output of the code example neural network encoder and the output of the natural language neural network encoder are tensors within a shared, high-dimension tensor space. In some embodiments, the code example neural network encoder and the natural language neural network encoder are comprised of a plurality of neural network layers, such as recurrent neural network layers and/or convolutional neural network layers and/or other layers. In some embodiments, the code example neural network encoder and the natural language neural network encoder may each be a machine learning network such as machine learning network 200. Similarity measure 1225 determines a similarity or distance between embeddings in the joint embedding space. In an embodiment, the distance between embeddings in the joint embedding space may be a cosine similarity determined by similarity measure 1225.

FIG. 12C illustrates the steps of a method for training a machine learning network such as neural network 200 for code example grouping. At step 1231, code examples and associated natural language text are identified and received. Associated text may be any kind of text associated with a code example, such as text appearing on the same page as the code example.

These textual sources are pre-processed at step 1232 to produce a training dataset. In some embodiments, textual sources are segmented into individual words, sentences, phrases, paragraphs, or other document chunks sub-segment for training. Each segment or sub-segment of a document determined to be related to a code example is provided as a training data to train a code example neural network encoder. The training dataset may be further filtered or processed to select the most relevant text to associated with a code example. For example, common words or phrases may be omitted from the training dataset. In addition, source code of a definition of a code example may be pre-processed or filtered for training machine learning models. For example, comments or non-code text may be omitted for training purposes, or variable names may be standardized or modified for training purposes.

At step 1233, a code example is provided to the code example neural network encoder and training data associated with the code example is provided to a natural language neural network encoder. The output of each encoder is a tensor embedding in a joint tensor space. That is, the output of the code example neural network encoder and the output of the natural language neural network encoder are tensors within a shared, high-dimension tensor space. In some embodiments, the code example neural network encoder and the natural language neural network encoder are comprised of a plurality of neural network layers, such as recurrent neural network layers and/or convolutional neural network layers and/or other layers.

At step 1234, the code example neural network encoder and the output of the natural language neural network encoder are jointly trained on the supplied training dataset comprising the code example and associated natural language textual data. A first tensor embedding of a code example from the code example neural network encoder is compared against a second tensor embedding from the natural language neural network encoder for a segment of natural language text that is associated with the code example. Backpropagation is used to adjust the parameters of the code example neural network encoder and the natural language neural network encoder so that the two embeddings are more similar or closer in the joint embedding space.

In some embodiments, negative examples of natural language text that is not associated with a code example may also be used to train the two neural networks. Positive examples comprise examples of natural language text that is associated with a code example. The neural network encoders may be trained to both maximize the similarities of positive examples and minimize the similarities of negative examples. The internal parameters of the two neural network encoders are adjusted by backpropagation to make the tensors closer in tensor space, for positive examples, and farther in tensor space, for negative examples.

At step 1204, a search query is received by the code examples database. In an embodiment, a search query may be received from a user interface presented on a web page of the code examples database provided for browsing and searching indexed code examples. In an embodiment, a search query may be received via an API provided by the code examples database for searching indexed code examples. For example, a search agent operating on a client may analyze a web page being displayed by the client and submit a query for code examples related to the content of the displayer web page on the client.

The code examples database may execute a search based on the search query using any method of search. For example, a keyword search based on the search query may be executed against the code examples database. In some embodiments a natural language search query may be received by the code example database and a natural language search based on the natural language search query executed on the code examples database.

FIG. 12D illustrates an exemplary method of searching for code examples by keyword. At step 1241, a keyword search query is received. A keyword search query may include a single keyword, an unordered plurality of keywords, an ordered plurality of keywords, a plurality of keywords related by Boolean search term operators, a segment of natural language text, or any combination thereof. In some embodiments, a search query may be filtered or pre-processed prior to executing a search. For example, in some embodiments, a query expansion routine may be used to find root stems of search terms and include related search terms in the search query.

At step 1242, the search query is executed against the database of indexed code examples. The database may be pre-processed to facilitate searching, and any indices may be generated to facilitate searching of the database. Any search engine or search methodology may be used to search the database for results pertaining to the search query. For example, a search engine may find all results that have a common keyword associated with them that is present in the search query. In some embodiments, the keywords do not need to be exact match and may be matched based on synonyms, semantic relationships, or other fuzzy matching.

At step 1243, the search engine returns any matching code examples that are responsive to the search query. A code example is responsive if one or more keywords associated with the code example is matched by the search engine to the search query. At step 1244, the search results including any matching code examples that are responsive to the search query are ranked and displayed.

FIG. 12E illustrates the steps of a method for searching for code examples based on joint embeddings according to an embodiment. A database or corpus of code examples is first processed to determine an embedding of each code example in a joint tensor space as described above. A user may then execute search queries against the database to search for code examples according to a search query.

At step 1251, a search query is received that may include keywords, natural language queries, or a combination of keywords and natural language queries. In some embodiments, the search query may be pre-processed at step 1252 to put the search query into a standard form. For example, punctuation present in the search query may be removed or a search query may be put into a standard capitalization format.

At step 1253, the search query is input into a trained natural language neural network encoder and an embedding of the search query is received from the natural language neural network encoder. The natural language neural network encoder may be trained according to a method such as described herein.

Next, at step 1254, the database of code example and their embeddings is evaluated to identify a set of embeddings of code examples that are close to the embedding of the search query in the tensor space. For example, code example embeddings that are within a threshold distance of the search query embedding may be selected as responsive to the search query. The distance between embeddings in the joint embedding space may be determined by a similarity measure such as a cosine similarity. In some embodiments, a fixed number of search results may be returned. For example, the code example embedding search engine may identify a top n number of code example embeddings in the joint embedding space. At step 905, the search results are ranked according to their distance from the search query embedding and returned for display and usage.

At step 1205, a list of code examples responsive to the search query is returned to the source of the search query. For example, if a search query were submitted via an API, the search results are returned via the API to the source of the search query. If a search query is received from a web page, search results may be returned via the web page. Search results may be returned ranked by the usefulness metric determined in step 1203.

FIG. 12F illustrates an exemplary method of searching for specification files. In some embodiments, a search may be received for specification files that specify code example execution environment parameters. This allows users to easily find and re-use environment specification parameters that may enable additional code examples to be executed. At step 1206, a specification file search query is received from any of the same sources as the search query of step 1204. A search for only specification files may then be executed at step 1207. Specification files responsive to the search query may then be returned to the source of the search query at step 1208. The same search methods for code examples, such as keyword and embedding approaches, may be used for specification files. For example, the methods illustrated in FIGS. 12A-E in the context of code examples may also be applied to specification files.

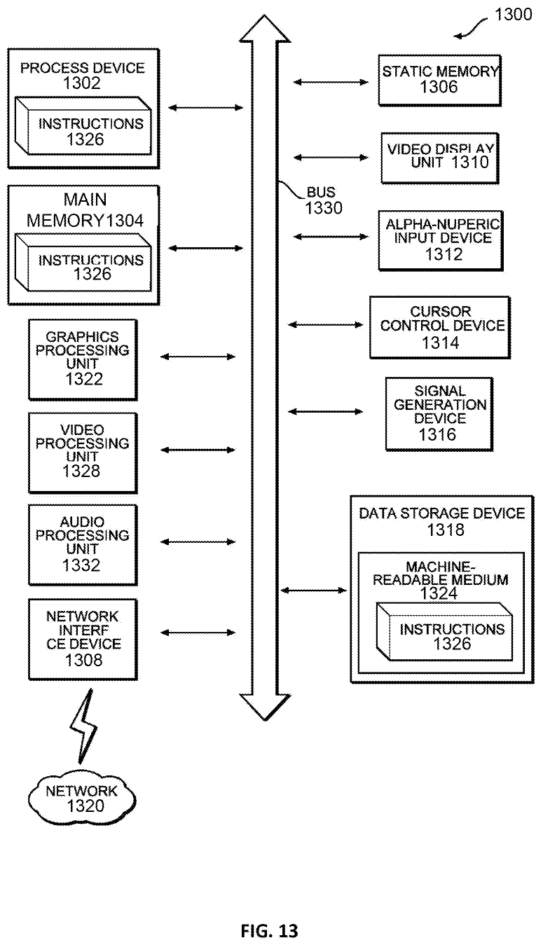

FIG. 13 illustrates an example machine of a computer system within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 1300 includes a processing device 1302, a main memory 1304 (e.g., read-only memory (ROM), flash memory, dynamic random access memory (DRAM) such as synchronous DRAM (SDRAM) or Rambus DRAM (RDRAM), etc.), a static memory 1306 (e.g., flash memory, static random access memory (SRAM), etc.), and a data storage device 1318, which communicate with each other via a bus 1330.

Processing device 1302 represents one or more general-purpose processing devices such as a microprocessor, a central processing unit, or the like. More particularly, the processing device may be complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 1302 may also be one or more special-purpose processing devices such as an application specific integrated circuit (ASIC), a field programmable gate array (FPGA), a digital signal processor (DSP), network processor, or the like. The processing device 1302 is configured to execute instructions 1326 for performing the operations and steps discussed herein.

The computer system 1300 may further include a network interface device 1308 to communicate over the network 1320. The computer system 1300 also may include a video display unit 1310 (e.g., a liquid crystal display (LCD) or a cathode ray tube (CRT)), an alphanumeric input device 1312 (e.g., a keyboard), a cursor control device 1315 (e.g., a mouse), a graphics processing unit 1322, a signal generation device 1316 (e.g., a speaker), graphics processing unit 1322, video processing unit 1328, and audio processing unit 1332.

The data storage device 1318 may include a machine-readable storage medium 1324 (also known as a computer-readable medium) on which is stored one or more sets of instructions or software 1326 embodying any one or more of the methodologies or functions described herein. The instructions 1326 may also reside, completely or at least partially, within the main memory 1304 and/or within the processing device 1302 during execution thereof by the computer system 1300, the main memory 1304 and the processing device 1302 also constituting machine-readable storage media.

In one implementation, the instructions 1326 include instructions to implement functionality corresponding to the components of a device to perform the disclosure herein. While the machine-readable storage medium 1324 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Various general purpose systems may be used with programs in accordance with the teachings herein, or it may prove convenient to construct a more specialized apparatus to perform the method. The structure for a variety of these systems will appear as set forth in the description below. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

A number of embodiments have been described. Nevertheless, it will be understood that various modifications may be made without departing from the spirit and scope of the invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A computer-implemented method comprising:
receiving a code example for execution;
parsing the code example to determine one or more attributes of the code example;
creating an execution environment on a computer system for running the code example and configuring the execution environment based on the one or more attributes of the code example;
running the code example in the execution environment on the computer system; and
capturing output from the code example.

2. The computer-implemented method of claim 1, further comprising:
parsing a displayed page to identify the code example.

3. The computer-implemented method of claim 2, wherein the code example is delimited in the page with one or more tags, and the page further comprises text related to the code example.

4. The computer-implemented method of claim 1, wherein the one or more attributes comprise at least a programming language of the code example, a dependency of the code example, and a set of configuration values for the execution environment for running the code example.

5. The computer-implemented method of claim 1, wherein the execution environment comprises a containerized image of a server, the containerized image comprising a server environment configured for running the code example.

6. The computer-implemented method of claim 1, wherein parsing the code example to determine one or more attributes of the code example includes using a machine learning model, statistical methods, or heuristics to determine the one or more attributes.

7. The computer-implemented method of claim 6, wherein the machine learning model is a neural network.

8. The computer-implemented method of claim 1, further comprising:
receiving first specification text for allowing the specification of one or more dependencies for running the code example.

9. The computer-implemented method of claim 1, further comprising:
receiving second specification text for configuring the output to be displaying based on the running of the code example.

10. The computer-implemented method of claim 9, wherein the second specification text comprises at least an option for displaying STDOUT and at least an option for displaying STDERR.

11. The computer-implemented method of claim 1, wherein configuring the execution environment includes configuring access to a database.

12. The computer-implemented method of claim 1, wherein configuring the execution environment includes installing dependencies.

13. The computer-implemented method of claim 1, wherein configuring the execution environment includes installing and running an additional program to communicate with the code example.

14. The computer-implemented method of claim 1, further comprising:
displaying output of the code example interleaved with code of the code example.

15. The computer-implemented method of claim 14, further comprising:
detecting that a line of code is executed more than once and grouping output from that line of code.

16. The computer-implemented method of claim 1, further comprising:
receiving input text requesting display of a file system listing, a file, or an image;
in request to the request, displaying the file system listing, file, or image.

17. The computer-implemented method of claim 16, wherein the input text comprises special commands that are not rendered in the code example.

18. The computer-implemented method of claim 1, further comprising:
scanning the code example for one or more hide indicators;
detecting a hide indicator and hiding a portion of the code example from rendering.

19. The computer-implemented method of claim 1, further comprising:
transmitting a network request, by the execution environment, to the running code example.

20. The computer-implemented method of claim 1, further comprising:
loading specification text, the specification text including one or more attributes for running the code example.

21. The computer-implemented method of claim 20, wherein the specification text includes configuration values for configuring the execution environment for running a code example.

22. The computer-implemented method of claim 20, wherein the specification text includes a programming language and one or more dependencies.

23. The computer-implemented method of claim 20, wherein the specification text includes instructions for initializing the execution environment and running the code example in the execution environment, where the execution environment is configured to run the code example with no additional configuration other than the specification text.

24. The computer-implemented method of claim 20, wherein the specification text is a template that is configured for use with more than one code example.

25. The computer-implemented method of claim 20, wherein the specification text includes an identifier of an input file and the input file is added to the execution environment before the code example is run.

26. A computer-implemented method comprising:
providing a database of code examples accessible within a code editing environment;
displaying popular code examples;
receiving input text in the code editing environment from the user;
searching for code examples in the database based on the input text;
returning a ranked list of code examples.

27. The computer-implemented method of claim 26, wherein the input text comprises code entered in the code editing environment.

28. The computer-implemented method of claim 26, wherein the input text comprises a search query string.

29. The computer-implemented method of claim 26, wherein the input text comprises code entered in the code editing environment and a search query string.

30. The computer-implemented method of claim 26, wherein the popular code examples are determined by views.

31. The computer-implemented method of claim 26, wherein the popular code examples are determined by user ratings.

32. The computer-implemented method of claim 26, wherein the popular code examples are determined by the frequency with which they have been selected by other users as correct answers to crowd-sourced questions.

33. The computer-implemented method of claim 26, wherein the ranked list of code examples is ranked by popularity.

34. The computer-implemented method of claim 26, further comprising:
running a code example in response to a request from a user; and
identifying a similar code example to the running code example, wherein the similarity is determined based on associated keywords of the similar code example and the running code example.
